(19) United States
(12) Patent Application Publication
(10) Pub. No.: US 2026/0119011 A1
(43) Pub. Date: Apr. 30, 2026

(54) MACHINE-LEARNING SYSTEM DATA-COLLECTION MANAGEMENT

(71) Applicant: Microsoft Technology Licensing, LLC, Redmond, WA (US)

(72) Inventors: Medhaj Suresh ATHILKAR, Seattle, WA (US); Emma Catherine NESTVOLD, Bellingham, WA (US); Manisha KUSUMA, Seattle, WA (US); David CHEN, Seattle, WA (US); Matthew Richard LICHTENBERG, Gates Mills, OH (US); Pratik Pankajbhai MISTRI, Bothell, WA (US); Yash MISRA, Kirkland, WA (US)

(21) Appl. No.: 18/925,308

(22) Filed: Oct. 24, 2024

(51) Int. Cl. G06F 3/0484; G06F 3/04817

(52) U.S. Cl. CPC G06F 3/0484; G06F 3/04817

(57) ABSTRACT

The technology described herein improves data security by giving users control over data collected by and/or for machine-learning (ML) systems through a computing system. A first aspect of providing control to the user is the display of a data-collection status indicator. The status indicator, which may take the form of an icon or other user interface feature, communicates whether data collection is active or inactive. A second aspect of providing control to the user is providing a data-collection management interface through which the information collected can be managed. The data-collection management interface allows the user to provide and/or edit data-collection policies and to delete previously collected data. These policies can establish criteria indicating when data may or may not be collected. The data-collection management interface may allow the user to pause data collection for a period of time.

### BACKGROUND

Users perform a wide variety of tasks with computing devices. Common tasks include booking travel, creating documents, video conferencing, and editing photos. Users often switch from one task to another, causing them to lose track of what they were working on. Similarly, when a user completes a task, the user may lose track of confirmation emails, itineraries, and other resources generated when performing the task. Traditional search and retrieval methods, such as keyword-based searches, folder hierarchies, and app-specific organization tools, are often inadequate for quickly resuming a task or finding resources generated when a task was performed. These methods rely on users remembering specific details about their past activities, which can be challenging due to the vast amount of information that users generate and interact with.

Recent developments with machine-learning (ML) systems allow users to retrieve and complete tasks with improved accuracy. However, in order to help the user track tasks and complete them, the machine-learning system may gather and/or access data about user activities performed through the computing device. It may be difficult for users to understand what information is being accessed by machine-learning systems and to control ML model access to the data. It is with respect to these and other considerations that the disclosure made herein is presented.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein improves data security by giving users control over data collected by and/or for machine-learning (ML) systems through a computing system. More specifically, the technology described herein provides operating system (OS) level control of machine-learning data-collection services. A first aspect of providing control to the user is the display of a data-collection status indicator. The status indicator, which may take the form of an icon or other user interface feature, communicates whether data collection is active or inactive. The data-collection indication may take first appearance when data collection is active and a second appearance when data collection is inactive. The first appearance may be a first icon design and the second appearance a second design. The first and second designs may be different colors or otherwise have different attributes.

A second aspect of providing control to the user is providing a data-collection management interface through which the information collected can be managed. The data-collection management interface allows the user to provide and/or edit data-collection policies. These policies can establish criteria indicating when data may or may not be collected. The data-collection management interface may allow the user to pause data collection for a period of time. The period may be an hour, day, week or some other boundary selected by the user.

The machine-learning data-collection services may collect user activity data in different forms. In one aspect, the user activity data takes the form of a graphical capture. Graphical capture of user activity may enable downstream user experiences generated by a machine-learning model, such as state recall.

The technology may present a data-collection control and status interface to the user in a consistent manner and/or non-obstructed location on the display regardless of the active application and/or interface(s) displayed. Conventional data-collection controls associated with a machine learning model can become obscured on the display when the machine-learning model interface is at least partially obstructed by one or more overlaying interfaces of other applications, minimized, or otherwise not on-screen. The user interface designs of machine-learning model applications also vary appreciably from one platform to another, without standard data-collection control icons or control logic, forcing users to learn the nuances of each different machine-learning application. The OS-level data-collection control service presented herein facilitates unambiguous presentation of a data-collection status and control interface.

The control interface can provide detailed user control over the ML data collection. The controls allow a user to turn on and off recording or capture of user activity data. The user can see when their user activity is being recorded. The user can pause recording for a period of time. The user can set automatic content filtering criteria to prevent user activity from being recorded when the criteria is met. For example, data collection may be deactivated when designated applications are active and/or in a certain state (e.g., browser is in private or incognito mode). In addition to applications, users may disable data collection on a per website basis or website category basis. The status icon can change to indicate that data collection is inactive when a filtering criteria is identified. In addition, a message, such as a toast message, may be displayed on the screen to indicate that the status has changed. When the filtering criteria is no longer met, the data collection may be activated and an activation message provided.

In addition to filtering collection of user activity data, users can delete already collected user activity data on a time basis (e.g., last week), application basis (e.g., web browser data), website specific basis, and/or file type specific basis, among other options. Access to user history data may be password protected.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example operating environment suitable for implementations of the present disclosure, according to an aspect of the technology described herein;

FIG. 2 is a block diagram of an example computing environment suitable for implementations of the present disclosure, according to an aspect of the technology described herein;

FIG. 3 is a flow diagram illustrating an example interaction between components that implement OS-level ML data-collection services for an ML data-collection application, according to an aspect of the technology described herein;

FIG. 4 is a flow diagram illustrating an ML data-collection application, according to an aspect of the technology described herein;

FIGS. 5A, 5B, and 5C are diagrams illustrating an example embodiment of an operating system's ML data-collection user interface, according to an aspect of the technology described herein;

FIGS. 6A-F are example screen displays illustrating an operating system's ML data-collection user interface, according to an aspect of the technology described herein;

FIG. 7 is a flow diagram showing an example method embodiment for ML data-collection management, according to an aspect of the technology described herein;

FIG. 8 is a flow diagram showing another example method embodiment for ML data-collection, according to an aspect of the technology described herein;

FIG. 9 is a flow diagram showing yet another example method embodiment for ML data-collection management, according to an aspect of the technology described herein; and

FIG. 10 is a block diagram illustrating a computing device suitable for use with aspects of the technology described herein.

### DETAILED DESCRIPTION

The various technologies described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein improves data security by giving users control over data collected by and/or for machine-learning (ML) systems through a computing system. More specifically, the technology described herein provides operating system (OS) level control of machine-learning data-collection services. A first aspect of providing control to the user is the display of a data-collection status indicator. The status indicator, which may take the form of an icon or other user interface feature, communicates whether data collection is active or inactive. The data-collection indication may take first appearance when data collection is active and a second appearance when data collection is inactive. The first appearance may be a first icon design and the second appearance a second design. The first and second designs may be different colors or otherwise have different attributes.

A second aspect of providing control to the user is providing a data-collection management interface through which the information collected can be managed. The data-collection management interface allows the user to provide and/or edit data-collection policies. These policies can establish criteria indicating when data may or may not be collected. The data-collection management interface may allow the user to pause data collection for a period of time. The period may be an hour, day, week or some other boundary selected by the user.

The machine-learning data-collection services may collect user activity data in different forms. In one aspect, the user activity data takes the form of a graphical capture. Graphical capture of user activity may enable downstream user experiences generated by a machine-learning model, such as state recall. Due to the significant portion of daily life that occurs via personal computing devices (e.g., laptops, personal computers, smartphones, tablets), service providers (e.g., operating system providers) may wish to enhance productivity and/or engagement through helpful user experiences. Such user experiences can be customized to a user's current context, preferences, and tendencies. As also mentioned above, these user experiences can be enabled by collecting, with the consent of the user, a record of user activity such as a graphical capture (e.g., a screenshot) of a desktop environment. Generally described, a desktop environment is a graphical user interface abstraction of an operating system that enables a user to intuitively interact with software applications on a computing device.

Graphical captures can take different forms. For example, user activity may be recorded all the time (e.g., via a constant screen recording) to enable a full and accurate recollection of moments of interest in past user activity. In another aspect, various triggers may be used that leverage operating system-level signals to cause a system to capture user activity. In the context of the present disclosure, a trigger is an explicit signal from a user experience (e.g., an application) to capture user activity. In a specific example, capturing user activity comprises generating a graphical capture (e.g., a screenshot) of on-screen content. For instance, a graphical capture can define a software application that is currently in-focus within the desktop environment. That is, while the user may have multiple software applications open, the user may interact with a single software application, or be determined by the system to interact with the single software application, at a given moment. This software application is accordingly said to be “in-focus”.

The graphical capture can then be provided to a downstream graphical capture consumer for use in various user experiences. In a specific example, the data consumer is an ML visual analysis tool that identifies onscreen content such as text, image(s), video, and so forth. The system can then quantify the operating system-level change utilizing a quantification mechanism that is selected based on the operating system component that was affected by the operating system-level change. In response to determining that the quantified operating system-level change satisfies the threshold level of change, the system then triggers a graphical capture of the desktop environment recording a current state of the desktop environment. As mentioned above, the graphical capture can represent the current visual layout of the desktop environment such as open software applications, content that the user is currently viewing (e.g., websites, documents), and the like.

The technology may present a data-collection control and status interface to the user in a consistent manner and/or non-obstructed location on the display regardless of the active application and/or interface(s) displayed. Conventional data-collection controls associated with a machine learning model can become obscured on the display when the machine-learning model interface is at least partially obstructed by one or more overlaying interfaces of other applications, minimized, or otherwise not on-screen. The user interface designs of machine-learning model applications also vary appreciably from one platform to another, without standard data-collection control icons or control logic, forcing users to learn the nuances of each different machine-learning application. The OS-level data-collection control service presented herein facilitates unambiguous presentation of a data-collection status and control interface.

The control interface can provide detailed user control over the ML data collection. The controls allow a user to turn on and off recording. The user can see when their user activity is being recorded. The user can pause recording for a period of time. The user can set automatic content filtering criteria to prevent user activity from being recorded when the criteria is met. For example, data collection may be deactivated when designated applications are active and/or in a certain state (e.g., browser is in private or incognito mode). In addition to applications, users may disable data collection on a per website basis or website category basis. The status icon can change to indicate that data collection is inactive when a filtered criteria is identified. In addition, a message, such as a toast message, may be displayed on the screen to indicate that the status has changed. When the filter criteria is no longer met, the data collection may be activated and an activation message provided.

In addition to filtering collection of user activity data, users can delete already collected user activity data on a time basis (e.g., last week), application basis (e.g., web browser data), website specific basis, and/or file type specific basis, among other options. Access to user history data may be password protected.

OS-level data-collection control services may be implemented, at least in part, by an application programming interface (API) service application of the user device's OS that is referred to herein as the Data Collection Coordinator (DCC). The data-collection control services offered via the DCC are consumed by one or more applications that are configured to interact with it. The DCC, in turn, communicates with an ML data-collection control interface provided by the OS. For example, the OS may display an ML data-collection control user interface in a taskbar or other region of the OS user interface. The data-collection control user interface presents a data-collection control and data-collection-status indication in a consistent manner regardless of which application is running. The controls and indication are provided regardless of whether the machine-learning model is operating within a visible interface or within an interface that is covered, minimized, off screen, or otherwise obscured.

As discussed in detail below, the DCC is notified when an ML data-collection application is actively recording user activity data. The DCC also monitors for messages from the ML data-collection application indicating that data collection is inactive (e.g., paused). The technology described herein allows the data-collection state to be controlled at the application level and/or the OS level. The data-collection state may be accurately indicated at both the OS level and the application level. When the ML data-collection application's data-collection function is in an inactive state, the ML data-collection application may not record user activity data. When the ML data-collection application's data-collection function is in an active state, the ML data-collection application may record user activity data.

The DCC communicates the current data-collection state, as reported by the ML data-collection application, to the ML data-collection user interface. The ML data-collection user interface then displays the current data-collection state as a status indication. The DCC also monitors for user interaction with the ML data-collection user interface. When the user operates the ML data-collection control provided by the OS-level ML data-collection user interface, the DCC sends a message to the ML data-collection application to update the ML data-collection application's data-collection state accordingly. For example, the user may select a virtual pause control button on the OS-level ML data-collection user interface to toggle the ML data-collection state from inactive to active, or vice versa. The DCC receives that information from the ML data-collection user interface and sends a message to the ML data-collection application to toggle the ML data-collection state, and the ML data-collection application responds to that message from the DCC accordingly. The DCC again monitors for a message from the ML data-collection application indicating the ML data-collection state has changed, and in response updates the data-collection status indication on the OS-level ML data-collection user interface. In this way, the ML data-collection user interface displays a status indication that is based on a confirmation message from the ML data-collection application of the current ML data-collection state. It should also be noted that at any one time, the computer system may be running more than one ML data-collection application, each with a respective data-collection method under its control. Accordingly, in some embodiments, the ML data-collection user interface may further display information indicating the ML data-collection state for each of the ML data-collection applications, and display data-collection control features that facilitate toggling of the ML data-collection state for each of the ML data-collection applications.

A machine-learning model, which is also referred to as an ML model, is a subset of artificial intelligence (AI) that involves the development of algorithms and statistical models that enable computers to perform tasks without explicit instructions. Instead, these systems learn from data. Types of machine learning methods include, but are not limited to, supervised learning, unsupervised learning, semi-supervised learning, reinforcement learning, self-supervised learning, and transfer learning. Supervised learning models are trained on a labeled dataset, which means that each training example is paired with an output label. The goal is for the model to learn to predict the output from the input data. Unsupervised learning models are given data without explicit instructions on what to do with it. The system tries to learn the patterns and the structure from the data. Semi-supervised learning models use a small amount of labeled data and a large amount of unlabeled data. Reinforcement learning models use an agent learns to make decisions by performing actions in an environment to maximize a measure cumulative reward. It learns from the consequences of its actions, rather than from being told explicitly what to do. Self-supervised learning models are a type of unsupervised learning where the data provides the supervision. The model generates labels from the input data itself. Transfer learning models take a pre-trained model on one task and adapt it to a new, but related, task. It leverages the knowledge gained from the initial task to improve learning on the new task.

Machine learning models can be built using different technologies. These technologies include, but are not limited to, Convolutional Neural Networks (CNNs), Recurrent Neural Networks (RNNs), Generative Adversarial Networks (GANs), Long Short-Term Memory Networks (LSTMs), Transformer Networks, Autoencoders, Deep Belief Networks, Attention Mechanisms (Often used in conjunction with other architectures, attention mechanisms allow the model to focus on specific parts of the input data, improving performance on tasks where certain parts of the data are more important than others), and Graph Neural Networks (GNNs).

In one aspect, the ML is able to use user data to respond to prompts or queries. The ML model may be based on natural language processing (NLP) and may be referred to as a conversational AI or chatbot. One example model is based on a transformer architecture, like GPT-4 (Generative Pre-trained Transformer 4). The technologies described herein help the use manage what user data is provided to the ML model.

Having briefly described an overview of aspects of the technology described herein, an exemplary operating environment in which aspects of the technology described herein may be implemented is described below in order to provide a general context for various aspects.

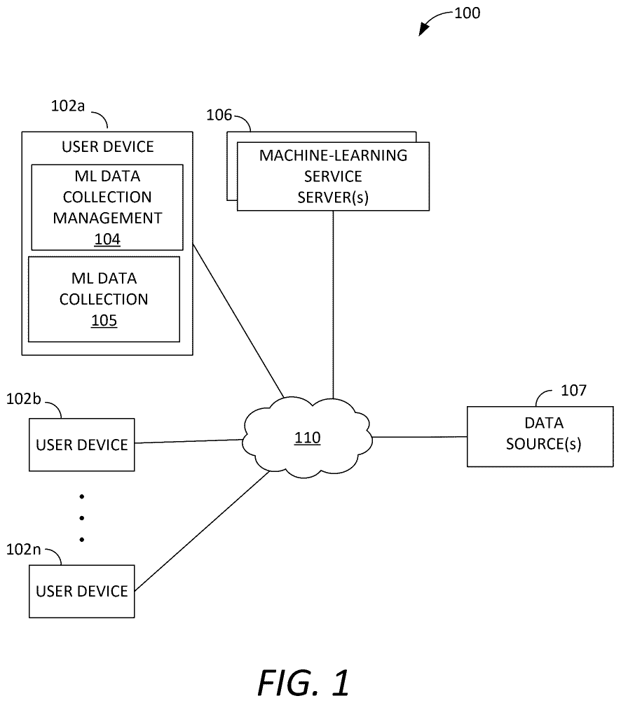

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and/or groupings of functions) may be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by at least one processor executing instructions stored in memory.

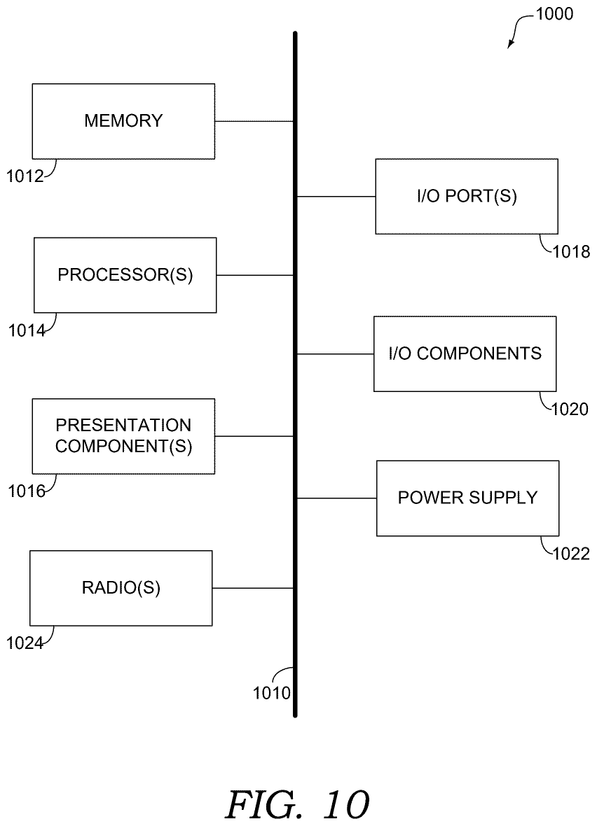

Among other components not shown, example operating environment 100 includes a number of user devices, such as user devices 102a and 102b through 102n; one or more servers 106, one or more data sources 107; and network 110. Each of the components shown in FIG. 1 may be implemented via any type of computing device, such as computing device 1000 described in connection to FIG. 10, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

User devices 102a and 102b through 102n may be client devices on the client-side of operating environment 100, while server(s) 106 may be on the server-side of operating environment 100. Server(s) 106 may comprise server-side software designed to work in conjunction with client-side software on user devices 102a and 102b through 102n to implement any combination of the features and functionalities discussed in the present disclosure. Data sources 107 may comprise data sources and/or data systems, which are configured to make data available to any of the various constituents of operating environment 100.

In aspects, the technology described herein may take the form of OS-level ML data-collection management services 104 running on any one or more of the user devices. For example, the user device 102a may comprise at least one ML data-collection application 105 that captures local computer usage data and then makes it available over network 110 to either an ML server 106 or data source 107.

The data sources 107 may comprise email servers, social media servers, cloud based concierge or shopping services, virtual assistants, gaming servers, or queryable database, for example. Data source(s) 107 may be discrete from server(s) 106 or may be incorporated and/or integrated into at least one of those components. The data sources 107 may include information used by the machine-learning service 106 to provide responses to user prompts. The data sources 107 may include information that is combined with a user's previous user activity data to provide a service to the user. The service can include providing a response to a prompt provided to the machine-learning service. The data sources 107 may include training data for the machine-learning service 106. In each of these various implementations, the OS-level ML data-collection services 104 controls the ML data-collection state of the ML data-collection application 105.

This operating environment 100 is provided to illustrate one example of a suitable environment, and there is no requirement for each implementation that any combination of server(s) 106, data source(s) 107 and user devices 102a and 102b through 102n remain as separate entities.

User devices 102a and 102b through 102n may comprise any type of computing device capable of use by a user. For example, in one aspect, user devices 102a through 102n may be the type of computing device described in relation to FIG. 10 herein. By way of example and not limitation, a user device may be embodied as a personal computer (PC), a laptop computer, a mobile device, a smartphone, a tablet computer, a smart watch, a wearable computer, a fitness tracker, a virtual reality headset, augmented reality glasses, a personal digital assistant (PDA), a video player, a handheld communications device, a gaming device or system, an entertainment system, a vehicle computer system, an embedded system controller, a remote control, an appliance, a consumer electronic device, a workstation, or any combination of these delineated devices, or any other suitable device.

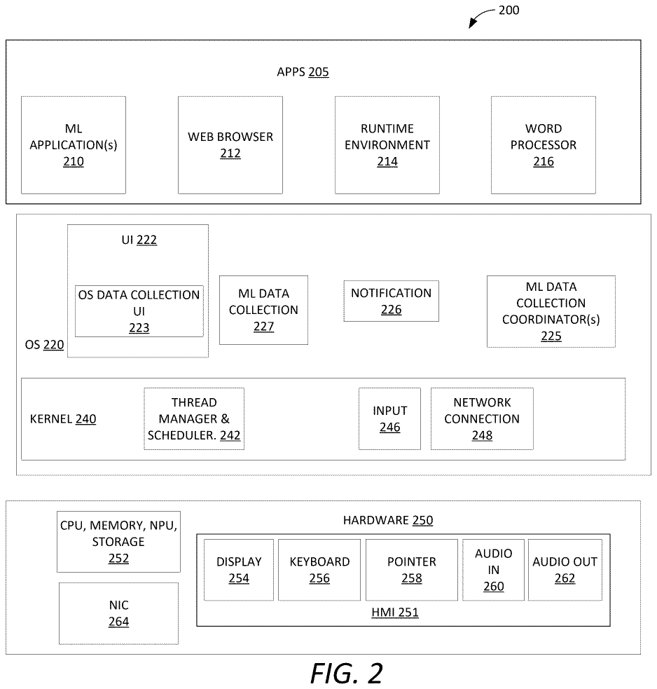

Operating environment 100 may be utilized to implement one or more of the components of a user device system architecture system 200, described in FIG. 2, including components for an OS-level ML data-collection services 104 for a user device 102a as illustrated in FIG. 1.

Some components described in FIG. 2 are described using terms often used to describe components of the WINDOWS operating system provided by MICROSOFT. However, aspects of the technology described herein are not limited to use with WINDOWS. The features of the technology described herein may be used with other operating systems, which include many of the same components and perform similar features.

The computing environment 200 comprises a hardware layer 250, operating system components 220 (which include kernel components 240) and example applications 205.

Among other components, the hardware layer 250 comprises one or more central processing units (CPUs), one or more neural processing units (NPU), a memory, and storage, collectively illustrated at 252. The hardware layer 250 also comprises one or more elements that together define a human-machine interface (HMI) 251 through which a user interacts with the system 200. The HMI 251 may comprise input/output (I/O) elements such as, but not limited to, a display 254, keyboard 256, pointer device 258, audio input 260 (such as an internal microphone or audio input port), audio output 262 (such as a speaker or audio output port), and/or a network interface controller (NIC) 264. The CPU, memory, and storage 252 may be similar to those described in FIG. 10. The display 254 may comprise any form of computing device display, touch screen, and/or augmented reality or virtual reality device. The pointer device 258 may comprise a mouse, track ball, touch screen, touch pad, natural user input (e.g., gesture) interface or some other input device that controls a location of an interface pointer. The keyboard 256 may be physical keyboard or touchscreen keyboard. The NIC 264 (also known as a network interface card, network adapter, LAN adapter or physical network interface, and by similar terms) is a computer hardware component that connects a computer to a computer network. The NIC 264 allows computers to communicate over a computer network, such as network 110, either by using cables or wirelessly. The NIC 264 may be both a physical layer and data link layer device, as it provides physical access to a networking medium and, for I.E.E.E. 802 standard networks and similar networks, and provides a low-level addressing system through the use of medial access control (MAC) addresses that are uniquely assigned to network interfaces.

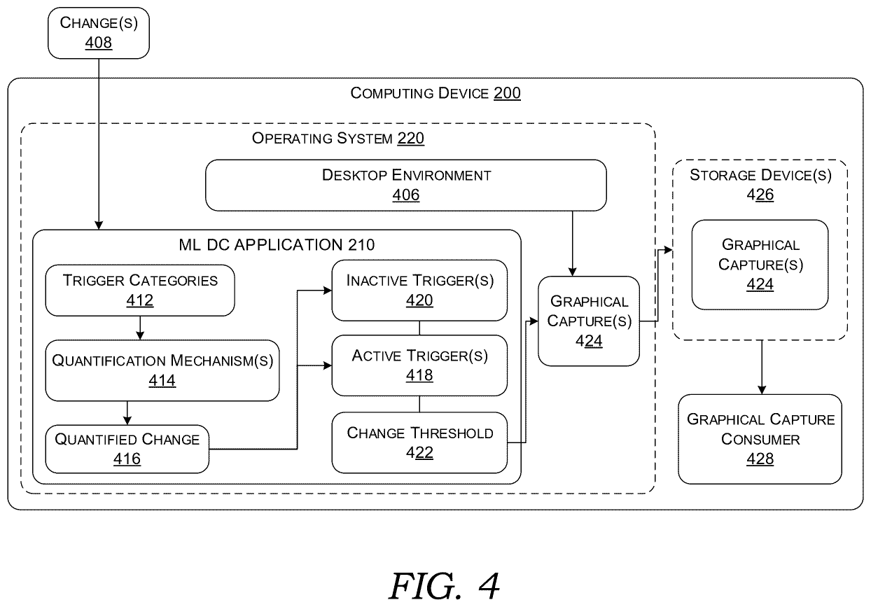

Applications 205 (which may also be referred to as user-mode applications) comprise software programs that are loaded into memory for execution by the CPU under the control of the operating system. Non-limiting examples of such applications may include spreadsheets, word processors, browsers, ML data-collection applications, and similar user applications. In the particular embodiment shown in FIG. 2, the application include one or more ML applications 210, a web browser 212, a runtime environment 214 (such as a Java, .NET framework, Visual Basic, or other runtime environments, for example), and/or other a word processing application 216, which is an example of an application (such as word processors, spreadsheets, drawing applications, and so forth), that may generate user activity data that is captured by the ML data-collection application 227. As previously discussed, an ML data-collection application 227 is an application that captures and records user activity data. The user activity data may be stored locally and made available to an ML application, such as ML application 210. The ML data collection coordinator 225 may receive user instructions to pause data collection and communicate the pause instruction to the ML data collection application 227. The ML data collection application 227 may collect user activity data in different forms. In one aspect, the user activity data takes the form of a graphical capture. Graphical capture of user activity may enable downstream user experiences generated by a machine-learning model, such as state recall. An exemplary ML data collection application 227 is described with reference to FIG. 4.

Together with components not shown, the operating system components 220 may be described as an OS, particularly an OS that implements OS-level ML data-collection services 104 as described herein. Some operating systems may combine a user mode and kernel mode or move operations around. In WINDOWS, the processor switches between the two modes depending on what type of code is running on the processor. Applications run in user mode, and core operating system components run in kernel mode. While many drivers run in kernel mode, some drivers may run in user mode.

When a user-mode application 205 starts, the operating system creates a process for the application. The process provides the application with a private virtual address space and a private handle table. Because an application's virtual address space is private, one application cannot alter data that belongs to another application. In addition to being private, the virtual address space of a user-mode application is limited. A processor running in user mode cannot access virtual addresses that are reserved for the operating system. Limiting the virtual address space of a user-mode application prevents the application from viewing, altering, and possibly damaging, critical operating system data.

Kernel components 240 share the same system address space (which is accessible only from kernel-mode). This means that a kernel-mode driver is not isolated from other drivers and the operating system itself.

Many components of the operating system, such as a hardware abstraction layer between the hardware and the kernel components 240, are not shown in FIG. 2. The kernel, of which the kernel components 240 are a part, is a computer program at the core of a computer's operating system and has control over the system. The kernel facilitates interactions between hardware and software components. The kernel controls hardware resources (e.g. I/O, memory) via device drivers, arbitrates conflicts between processes concerning such resources, and optimizes the utilization of common resources (e.g. CPU, memory, and storage 252). On some systems, the kernel is one of the first programs loaded on startup (after the bootloader). Once loaded, the kernel may handle the rest of startup as well as memory, peripherals, and input/output (I/O) requests from software, translating them into data-processing instructions for the CPU.

The code of the kernel may be loaded into a separate area of memory, which is protected from access by applications 205 or other, less critical parts of the operating system. The kernel performs its tasks, such as running processes, managing hardware devices such as the hard disk, and handling interrupts, in this protected kernel space. In contrast, applications 205 may use a separate area of memory, sometimes described as a user mode. This separation helps prevent user data and kernel data from interfering with each other and causing instability and slowness, as well as preventing malfunctioning applications from affecting other applications or crashing the entire operating system.

The kernel components 240, may include, for example, a thread manager and scheduler 242, an input manager 246, and a network connection manager 248. The thread manager and scheduler 242 handles the execution of threads in a process. An instance of a program runs in a process and each process may be assigned an ID that identifies it. A process many have any number of threads depending upon the degree of parallelism desired and each thread has an ID that identifies it. A machine with more than one processor can run multiple threads simultaneously, though multi-threading can also be implemented with a single processor.

The input manager 246 facilitates hardware input from the HMI 251. Device drivers provide the software connection between the devices of the HMI 251 and the operating system. The input manager 246 manages the communication between applications and the interfaces provided by such device drivers. The network connection manager 248 manages communications between the NIC 264, operating system components 220, and applications 205. The network connection manager 248 may provide network context information. The network manager may interact with one or more drivers to implement networking in the operating system.

The operating system components 220 also comprise components that may be considered part of the OS shell, such as user interface (UI) component 222, and notification component 226. The UI component 222 provides the operating system's main user interface, such as the desktop, on which applications 205 are presented within an interface. The notification component 226 manages notifications provided through the UI component 222 of the operating system. Notifications may originate from an application 205 or from a service of the OS 220.

In one aspect, the UI 222 outputs an ML data-collection user interface 223. The technology described herein provides OS level control of machine-learning data-collection services. A first aspect of providing control to the user is the display of a data-collection status indicator. The status indicator, which may take the form of an icon or other user interface feature, communicates whether data collection is active or inactive. The data-collection indication may take first appearance when data collection is active and a second appearance when data collection is inactive. The first appearance may be a first icon design and the second appearance a second design. The first and second designs may be different colors or otherwise have different attributes. The status indicator may be generated by the ML data-collection user interface 223.

A second aspect of providing control to the user is providing a data-collection management interface through which the information collected can be managed. The data-collection management interface may be provided by the ML data-collection user interface 223. The data-collection management interface allows the user to provide and/or edit data-collection policies. These policies can establish criteria indicating when data may or may not be collected. The data-collection management interface may allow the user to pause data collection for a period of time. The period may be an hour, day, week or some other boundary selected by the user.

The technology may present a data-collection control and status interface to the user in a consistent manner and/or non-obstructed location on the display regardless of the active application and/or interface(s) displayed. Conventional data-collection controls associated with a machine learning model can become obscured on the display when the machine-learning model interface is at least partially obstructed by one or more overlaying interfaces of other applications, minimized, or otherwise not on-screen. The user interface designs of machine-learning model applications also vary appreciably from one platform to another, without standard data-collection control icons or control logic, forcing users to learn the nuances of each different machine-learning application. The OS-level data-collection control service presented herein facilitates unambiguous presentation of a data-collection status and control interface.

The control interface can provide detailed user control over the ML data collection. The controls allow a user to turn on and off recording or capture of user activity data. The user can see when their user activity is being recorded. The user can pause recording for a period of time. The user can set automatic content filtering criteria to prevent user activity from being recorded when the criteria is met. For example, data collection may be deactivated when designated applications are active and/or in a certain state (e.g., browser is in private or incognito mode). In addition to applications, users may disable data collection on a per website basis or website category basis. The status icon can change to indicate that data collection is inactive when a filtering criteria is identified. In addition, a message, such as a toast message, may be displayed on the screen to indicate that the status has changed. When the filtering criteria is no longer met, the data collection may be activated and an activation message provided.

In addition to filtering collection of user activity data, users can delete already collected user activity data on a time basis (e.g., last week), application basis (e.g., web browser data), website specific basis, and/or file type specific basis, among other options. Access to user history data may be password protected.

The DCC 225 comprises an API that may communicate with the ML data-collection applications 227 to manage data collection activation and deactivation, among other data collection management functions. DCC 225 also communicates with an operating system ML data-collection user interface 223 presented on the display 254 by the UI 222. In some embodiments, the DCC 225 exchanges data-collection status and control information messages with the ML data-collection user interface 223 for OS-level ML data-collection services 104 through the notification component 226. In other embodiments, the notification component 226 is not utilized for OS-level ML data-collection services 104.

In some embodiments, an ML application 210 may comprise a web application or applet executed within a web browser 212 or runtime environment 214. In such embodiments, the web application or applet functions in the same manner as described herein for an ML application 210 with the understanding that the web browser 212 or runtime environment 214 within which it operates would comprise the functionality (for example, one or more APIs) to pass messages between the web application or applet and the DCC 225. The ML application 210 may respond to user prompts or queries. The ML application 210 may provide a recall experience that allows the user to return to a previous computing state or experience by matching a query with stored user activity data.

The ML data-collection user interface 223 is displayed by the HMI 251 on the display 254. The ML data-collection user interface 223 includes a data-collection status indication. The ML data-collection user interface 223 also includes a data-collection control that the user can interact with, for example, using a pointer device 258 or touch screen feature of the display 254, or using voice commands received at the audio in 260. The ML data-collection user interface 223 remains readily accessible to the user regardless of how the application 205 interfaces are otherwise presented on the display 254. In this example, the ML data-collection application 210 is running on a desktop/laptop user device.

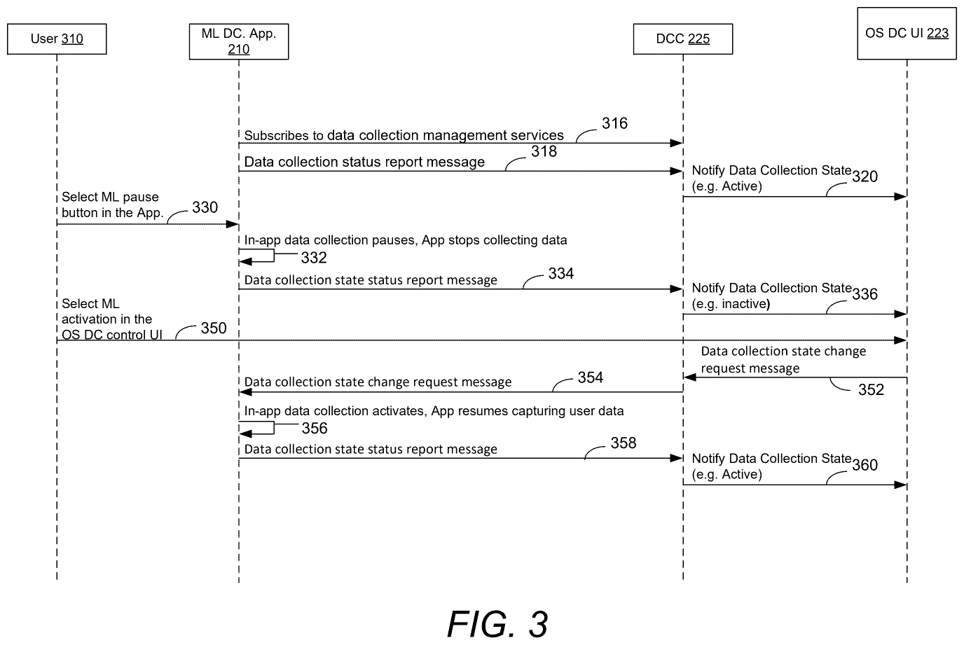

FIG. 3 is a flow diagram 300 illustrating an example interaction between various components that implement OS-level ML data-collection services 104. Included in this example are the interactions between the HMI 251 (which displays the ML data-collection user interface 223), an ML data-collection application 210, and the DCC 225.

The ML data-collection application 210 is programed to interact with the OS-level ML data-collection services 104. Initially, the ML data-collection application 210 may send a subscription request message 316 to the DCC 225. The DCC 225 can support multiple ML data-collection applications 210, though only one is shown in FIG. 3 for the sake of simplicity. The DCC 225 also receives a data-collection status report message 318 from the ML data-collection application 210 indicating the current ML data-collection state of the ML data-collection application 210. The data-collection state of the ML data-collection application 210 may be based on inputs provided by the user 310 to a user interface associated with the ML data-collection application 210. Based on the current ML data-collection state reported by the ML data-collection application 210, the DCC 225 instructs the UI 222 to display the DC UI 223 with an indication of the current ML data-collection state (shown at 320).

When the ML data-collection application's data-collection function is in an active state (e.g., not paused), the ML data-collection application 210 captures computer state data and the DC UI 223 is updated by DCC 225 to indicate that ML data-collection is active. When the ML data-collection application's data-collection function is in an inactive state, the ML data-collection application 210 has suspended data collection and the DC UI 223 is updated by DCC 225 to indicate that data collection is not active. The DCC 225 continues to monitor for the reception of data-collection-state status messages from the ML data-collection application 210 and also monitor for the reception of ML data-collection state change requests from the DC UI 223.

As shown at 330, when the user 310 interacts with the ML data-collection application 210 to toggle the current ML data-collection state of the ML data-collection application, the ML data-collection application 210 will respond by toggling its ML data-collection state from active to inactive, or vice versa, and then send an ML data-collection state status report message 334 to the DCC 225 to update the data-collection status indication on the DC UI 223. For example, at 330, the user 310 selects a pause button provided directly by the ML data-collection application 210. The ML data-collection application 210 deactivates the data-collection function (shown at 332). ML data-collection application 210 sends the ML data-collection state status report 334 to the DCC 225 notifying the DCC 225 that the data collection is now inactive. The DCC 225 notifies the DC UI 223 (shown at 336) to update the data-collection status indication on the DC UI 223 to inactive. It should be noted that the DC UI 223 may remain in the active state if any ML data-collection application is running. In the example illustrated in FIG. 3, only one ML data-collection application 210 is present and the OS DC UI 223 may be changed in response to the status report message 324.

Alternatively, the user 310 may instead interact with the OS DC UI 223 to toggle the data-collection status. As shown at 350, for example, the user 310 selects the data-collection control provided directly by the OS DC UI 223 to toggle the current ML data-collection state. The DC UI 223 sends a DC-state change request message 352 to the DCC 225, and the DCC 225 sends a corresponding DC-state change request message 354 to the ML data-collection application 210. The ML data-collection application 210 responds at 356 by toggling the ML data-collection state from active to inactive, or vice versa, and then sends an ML data-collection state status report message 358 to the DCC 225 to update (shown at 360) the data-collection status indication on the DC UI 223. For example, at 350, the user 310 selects a pause button provided by the DC UI 223 to request a pause in data collection. DC UI 223 sends DC-state change request message 352 to the DCC 225 and the DCC 225 sends a corresponding request 354 to the ML data-collection application 210. The ML data-collection application 210 activates the data-collection function (at 356) and resumes data collection. ML data-collection application 210 sends the DC-state status report message 358 to the DCC 225 notifying the DCC 225 that the data collection is now active. The DCC 225 updates the data-collection status indication on the DC UI 223 (shown at 360) to show that the data collection is active.

FIG. 4 illustrates user device system architecture 200 for a computing device (e.g., a laptop, a personal computer, a smartphone, a tablet) having an operating system 220 installed that is configured to capture a record of user activity within a desktop environment 406 in the manner briefly described above. A desktop environment 406 is a graphical user interface abstraction of an operating system that enables a user to intuitively interact with software applications on a computing device. In operation, the computing device can receive a change 408 at the operating system 220. The change 408 can include any input to one or more components of the operating system 220, such as a rendering of onscreen content, a signal from a user input device (e.g., a keyboard, a mouse, a touchscreen), a file system update, a network status, and so forth. As such, the change 408 is referred to herein as an operating system-level change.

The change 408 may be processed by the ML data-collection application 210 using a trigger mechanism. As shown, the trigger mechanism can include various trigger categories 412 to categorize the change 408, e.g., based on which component of the operating system 220 was affected by the change 408. For example, a series of keystrokes can be categorized under the trigger categories 412 as a “user input” type change. In another example, loading a new webpage can be categorized under the trigger categories 412 as an “onscreen content” type change. In a third example, a user saving a file and/or creating a new file can be categorized under the trigger categories 412 as an “internal operation” type change. It should be understood that the trigger mechanism can define any number of trigger categories 412 to capture the diversity of possible types of the change 408.

The trigger mechanism can further define a quantification mechanism 414 for additional processing of a change 408. In various examples, the quantification mechanism 414 is selected based on the categorization of the change 408 under the trigger categories 412. That is, a “user input” type change and an “onscreen content” type change can be accordingly processed by different quantification mechanisms 414. Stated another way, changes 408 of different trigger categories 412 can be quantified utilizing different methods.

To illustrate this, consider again the examples mentioned above. For a “user input” type change, the quantification mechanism 414 can be configured to recognize certain patterns of user inputs and/or actions, such as keyboard shortcuts (e.g., copy-paste), pointer movement (e.g., with a mouse), and the like. For an “onscreen content” type change, the quantification mechanism 414 may be an artificial intelligence (AI) embedding model that is configured to generate embeddings of onscreen content (e.g., text, images, webpages). Specific examples of embedding models include principal component analysis (PCA), singular value decomposition (SVD), and WORD2VEC by GOOGLE. Techniques such as principal component analysis and singular value decomposition are dimensionality reduction techniques that transform data from a high-dimensional representation (e.g., rendered text and images) to a low-dimensional representation (e.g., a numerical vector). The low-dimensional representation retains at least some of the meaningful properties of the original high-dimensional representation. In another example, techniques such as WORD2VEC utilize a shallow neural network to learn word associations from a training dataset containing a large corpus of words. As such, the WORD2VEC model can be configured to predict a target word from a given context using a continuous bag of words (CBOW) approach or, conversely, predict a context from a given target word via the skip-gram approach. While specific techniques for generating embeddings are mentioned herein, it should be understood that any suitable method can be used to generate embeddings from onscreen content.

As mentioned above, embeddings are numerical representations of content that enable computational analysis such as by another artificial intelligence model. For an “internal operation” type change, which may result in little or no visual change in the desktop environment 406, the quantification mechanism 414 can be configured to poll the affected operating system component to determine the action accomplished by the change such as opening a file, toggling a device setting, saving a file, playing and/or pausing audio, and so forth.

As a result of processing by the quantification mechanism 414, the change 408 becomes a quantified change 416 that can undergo analysis by the trigger mechanism in accordance with specific active triggers 418 and/or inactive triggers 420. Generally described, a trigger is a condition that, when met, sends an explicit signal to capture a record of user activity in the desktop environment 406. Consequently, triggers can be configured to capture the record of user activity at certain moments of interest to minimize data collection. That is, triggers can represent moments that the user may wish to return to at a later time.

Some examples of triggers include a timer which causes a capture at regular time intervals (e.g., every five seconds) in which the change 408 is an elapsed time period and the quantified change is the number of seconds in the elapsed time period. A more sophisticated trigger can detect certain keyboard shortcuts such as copy/paste, a screenshot shortcut, and/or a user configured shortcut to capture the current moment. In another example, a trigger can detect certain user actions within the desktop environment such as minimizing and/or maximizing a software application, toggling a device setting (e.g., muting/unmuting a microphone), moving a pointer through the desktop environment 406, an eye gaze towards certain portions of the desktop environment, a voice input, a particular keyboard shortcut, and so forth. In still another example, a trigger can be based on an analysis of onscreen content via numerical representations of onscreen content such as the embeddings mentioned above. In still another example, the trigger mechanism can be exposed to other entities by way of a trigger API to enable standalone applications within the operating system 220 to define and capture their own moments of interest. In a specific example, a standalone application generates a signal that is directed to the trigger application programming interface. Accordingly, the signal defines a command to the trigger application programming interface to generate a graphical capture.

In various examples, certain triggers can be manually and/or automatically configured as active triggers 418 or inactive triggers 420. For instance, the ML data-collection application 210 may determine that a user typically does not utilize a particular keyboard shortcut and in response, the ML data-collection application 210 can configure a trigger associated with the particular keyboard shortcut as an inactive trigger 420. Conversely, the ML data-collection application 210 may determine that an infrequently used keyboard shortcut indicates an important moment that is worth capturing in the event the keyboard shortcut is used. As such, the trigger associated with the keyboard shortcut can be configured as an active trigger 418. In addition, the active triggers 418 and/or the inactive triggers 420 can also be manually customized by user preferences.

In addition, active triggers 418 can transition to inactive triggers 420 in response to certain conditions and/or user context within the desktop environment 406. For instance, the user may be viewing personal financial information on a banking website. In response, an active trigger 418 associated with onscreen content may transition to an inactive trigger 420 to prevent capturing sensitive information and respect the privacy of the user. In another example, the user may be playing a video game in which certain sequences of user inputs to perform actions in-game may match certain active triggers 418 that apply outside of the video game. As such, the application 210 can transition these active triggers 418 to inactive triggers 420 when the user launches the video game. Moreover, dynamically disabling some or all of the ML data-collection application 210 can reduce resource consumption during particularly demanding tasks such as gaming.

Furthermore, the ML data-collection application 210 can be configured to learn user habits and/or tendencies over time to intelligently configure the active triggers 418. In a specific example, the ML data-collection application 210 learns that certain location changes are more likely to represent a moment of interest for graphical capture. Specifically, the trigger mechanism can utilize a location service to configure an active trigger 418 for capturing user activity based on a location change. For instance, the ML data-collection application 210 can determine, via the location service, that a user tends to leave home and head to an office for work around the same time each day indicating a potential moment of interest for graphical capture. Accordingly, the ML data-collection application 210 can configure an active trigger 418 to capture user activity in response to a location change from a home location to a work location. Consequently, a location change from the home location to a café can be excluded from the active trigger 418.

In conjunction with the active triggers 418, the ML data-collection application 210 can include a change threshold 422 to determine when to capture a record of user activity. In some examples, the change threshold 422 can be a binary value such as determining whether a device setting was toggled on or off, determining whether a sequence of user inputs matches a predetermined sequence, and the like. Alternatively, the change threshold 422 can be a predefined quantity such as a threshold number of seconds that have elapsed, a threshold level of difference calculated between a first set of embeddings and a second set of embeddings, and so forth.

In the event a quantified change corresponds to an active trigger 418 and satisfies the change threshold 422, the ML data-collection application 210 causes the operating system 220 to generate a graphical capture 424 of the desktop environment 406. In examples, the graphical capture 424 is stored locally within a storage device 426 of the computing device. From the storage device 426, a graphical capture consumer 428, such as ML DC Application 210, can access the graphical capture 424 for use in downstream user experiences such as activity recall. As mentioned above, to respect user privacy and/or comply with data privacy regulations, the graphical captures 424 may be stored locally to the computing device and may not be transmitted to any entities outside of the computing device.

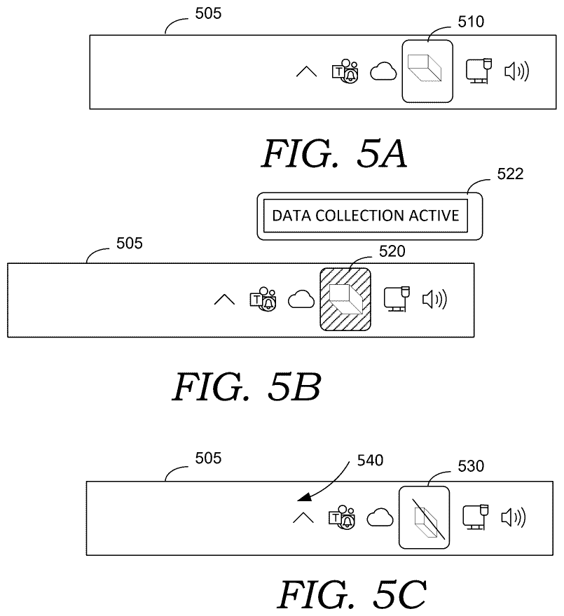

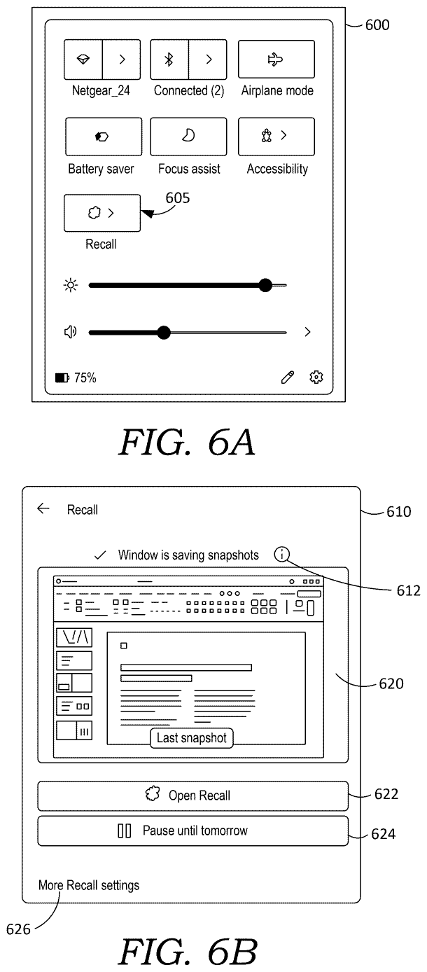

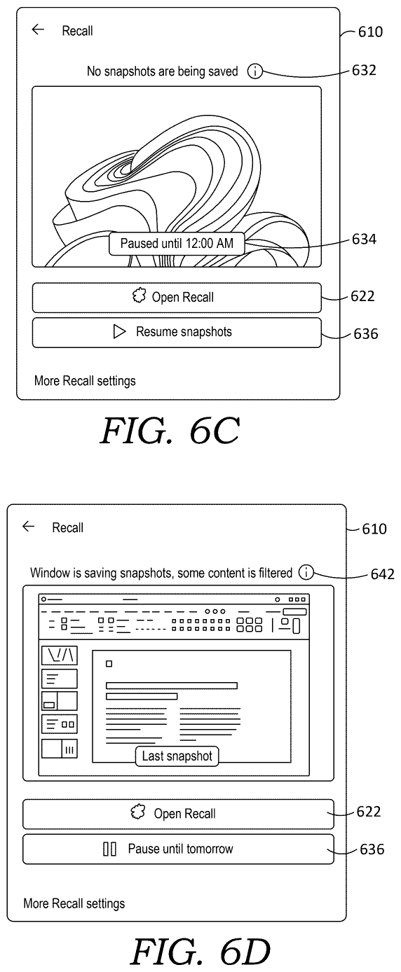

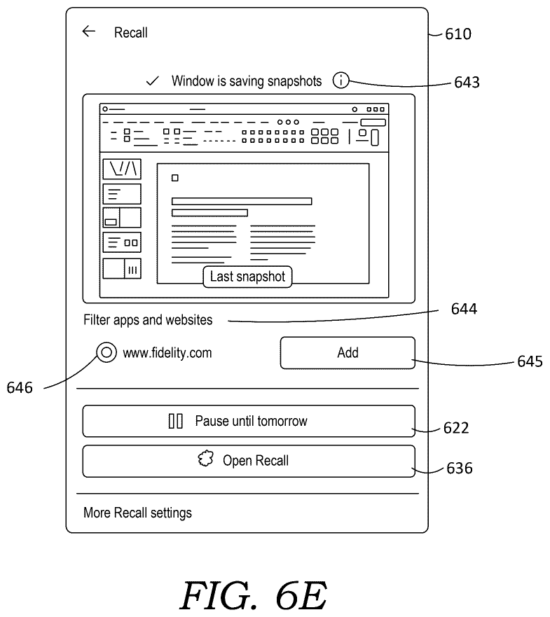

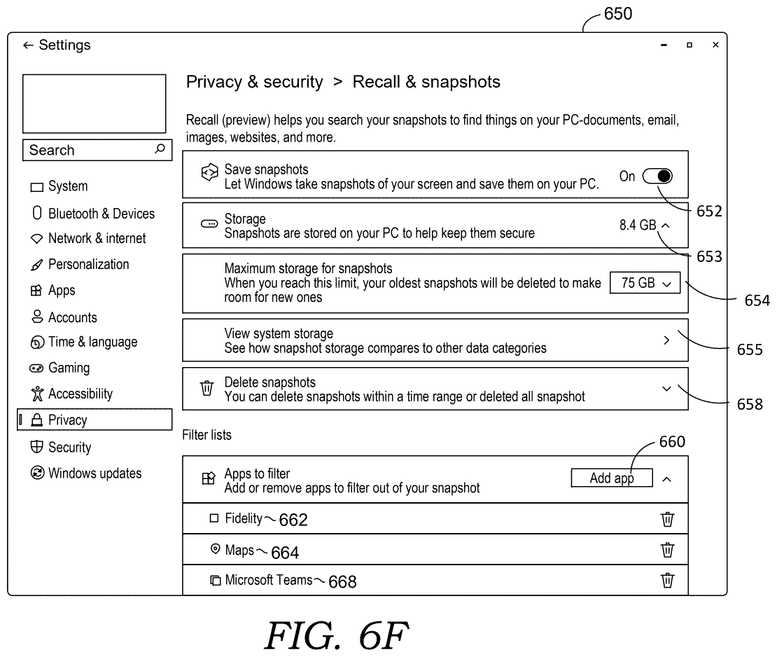

FIGS. 5A, 5B, and 5C illustrate an example data-collection status icon implementation. The data-collection status icon may be generated by the DC UI 223 component. In this example, the data-collection status icon is implemented using a symbol, in this case comprising a cube icon 510, located within and defining an element of an OS taskbar 505. It should be noted that the cube icon 510 is used for illustration purposes only, and in other embodiments, other symbols or text may be used in place of or in addition to a cube icon for the data-collection status icon. In this example, the cube icon 510 functions as both the data-collection control and the data-collection status indication. However, in other embodiments the DC control and the data-collection status indication can be realized using separate distinct icons for each respective function. In addition, the data-collection control interface may alternatively be presented through a second UI accessed through the data-collection status icon, as illustrated in FIG. 6. In that aspect, the cube icon 510 may change appearance to show active/inactive status and also allow the user to access a data-collection control menu.

Referring first to FIG. 5A, the active cube icon 510 is an element of the taskbar having a first appearance, corresponding to an active data-collection state. This indicates that an ML data-collection application is capturing user activity data. In some embodiments, when the user hovers a pointer over the active cube icon 510, the system may display which ML application is capturing user activity data.

Referring to FIG. 5B, the mid-interaction cube icon 520 provides a highlighted background upon a user hovering over the mid-interaction cube icon 520. The highlighted background communicates to the user that the interactive element may receive input, such as a click or hover. In one aspect, a user selecting the mid-interaction cube icon 520 will cause the DCC 225 to send an ML data-collection state change request into the ML data-collection application. The ML data-collection application will handle the request and then report the updated current ML data-collection state back to the DCC 225, which then updates the appearance of the cube icon 520 to reflect the current ML data-collection state reported by the ML data-collection application. In the example of FIG. 5B, the mid-interaction cube icon 520 comprises a cube icon over a highlighted background indicating that the data collection is active.

Hovering over the mid-interaction cube icon 520 (or any version of the cube icon) may cause a toast 522 to be displayed. The toast 522 may indicate whether the data collection is active or inactive. In some embodiments, when the user hovers a pointer 525 over the cube icon 530, the system may display which ML applications are collecting user activity data.

FIG. 5C shows a corresponding example of an inactive cube icon 530 comprising a slashed cube icon over a non-highlighted background indicating that the data collection is inactive (e.g., paused).

Although FIGS. 5A-5C illustrate the data-collection status icon implemented as an element of an OS taskbar, it should be understood that in other embodiments the data-collection status icon can be implemented in other ways. For example, the data-collection status icon can otherwise be implemented within other OS managed resources such as a system tray, dock, icon bar, menu bar, notification center, or panel. Regardless of the implementation, the data-collection status icon displayed ML data-collection state is linked to the ML data-collection state reported by the ML data-collection application. This means that when the user selects the data-collection status icon to toggle ML data-collection state, selecting it will not directly change the displayed ML data-collection state. Instead, the DCC 225 will dispatch the ML data-collection state change request message to the ML data-collection application, and then once the ML data-collection application changes the ML data-collection state, the appearance of the data-collection status icon will update accordingly. As previously explained herein, in some embodiments, when multiple ML data-collection applications have subscribed to the OS-level ML data-collection services 104, the data-collection status icon will indicate that the data collection is inactive when all ML data-collection applications report that their respective data-collection methods are inactive (i.e., a logic AND), and will indicate that DC function is active when any of the ML data-collection applications report that their respective user active data-collection activities are active (i.e., a logic OR).

Turning now to FIG. 6A-F, the operation of an ML data-collection control interface is illustrated. FIG. 6A shows a system tray details view 600. The system tray details view 600 may be accessed by interacting with the DC UI 223, by selecting the arrow icon 540 from the system tray, or in any other suitable manner. The system tray details view 600 includes a recall details button 605 along with other controls. In this example, the recall application is gathering user activity records in the form of a screen capture, as previously described in detail with reference to FIG. 4. Thus, the recall application is an example of an ML data collection application. Selecting the recall details button 605 will open the recall details interface 610 shown in FIG. 6B.

The recall details interface 610 includes data-collection status information and a broad control interface. A data-collection status indicator 612 is provided at the top of the recall details interface 610. In this example, the status indicator communicates that snapshots are being saved. The recall details interface 610 also includes a thumbnail 620 of the last snapshot saved. The recall details interface 610 includes an open recall button 622 that allows the user to adjust recall settings, as shown in FIG. 6E. The pause until tomorrow button 624 allows the user to cease data collection until the next day. This is just one example of a default pause duration. More specific pause durations could be accessed by selecting the more recall settings button 626 or the open recall button 622.

FIG. 6C shows a recall details interface 610 after the pause until tomorrow button 624 is selected. Status indicator 632 communicates that no snapshots are being saved. In other words, the data collection is inactive. The most recently saved snapshot has been replaced with a message 634 indicating that the data collection is paused until 12 AM. The pause button 624 has been replaced with a resume snapshots button 636. FIG. 6D shows a different status message 642 indicating that snapshots are being saved but some content is being filtered. More granular control over the user activity data saved may be given through a recall control interface 650 shown in FIG. 6F.

FIG. 6E shows a status message 643 indicating that snapshots are being saved. FIG. 6E includes an application and filter interface 644 that allows the user to pause and/or prohibit data collection for a particular website or application. In one aspect, an active website (a website being displayed in a browser when the recall details interface 610 is opened) and/or application is provided as a filter option. Upon selecting the active website 646 and selecting the add button 645, the website is added to a filtered list and data will not be collected from the website. In some instances (not shown), multiple active websites and/or applications could be shown in the filter interface and selected. The add button would then add all selected websites and/or application to the filter list.

The recall control interface 650 of FIG. 6F includes an on/off toggle 652 that turns data collection on or off. In one aspect, the default setting is off and a user must specifically turn the data collection system on. For added security, user credentials may be required in order to turn the data collection system on. For example, the user may need to provide a password to turn the data collection system on. Turning the system on or off is different from the previously described pause function, which pauses data collection for a period while the system remains on. When the system is off, data collection will remain off until turned back on via a user instruction. In contrast, pause turns the data collection off until the pause criteria is met, at which point data collection resumes without an affirmative user instruction to resume. The storage information interface 653 shows the user how much memory is being used to store snapshots. The storage control function 654 allows the user to allocate more or less memory to the ML data collection system. The control may provide a memory allocation update showing the amount of allocated memory currently in use by the data collection system. As described previously, the user activity data, such as screenshots, may be saved locally. The memory comparison view 655 shows the user memory allocated to the data collection system compared to other memory uses (e.g. memory allocated to music, videos, and pictures).

Though not shown, a data retention control may allow the user to determine how long user activity data is saved. In aspects, the recorded user activity data may be deleted after a duration of time, such as after three months pass. If the memory allocated to the user activity data becomes full, then the oldest user activity data may be deleted to make room for newer data. Other methods for managing user activity data within the allocated storage are possible.

The memory clearing function 658 allows the user to delete recorded user activity records. In one aspect, the user can delete all saved records. In another aspect, the user can delete all records collected during a particular time period, such as the last hour, last day, or last week. In another aspect, the user can navigate through thumbnails of user activity records and delete portions of them.

The filter list allows the user to prevent user activity records from being recorded when certain applications are active. The user may designate a new application for filtering by selecting the add app button 660. Selection of the add app button 660 may bring up a list of applications available on the computing device and allow the users to select applications to filter. Where an application is filtered that means that user activity data will not be collected when the filtered application is in focus. Alternatively, any interface through which the filtered application is displaying content may not be included within user activity data. In the illustrated example, the filtered applications include the Fidelity application 662, the maps application 664, and the Microsoft Teams application 668. Though not shown, an ability to filter by application and/or information categories may also be provided. For example, a user could add all financial applications and/or information to a filter list. As another example, all videoconferencing applications and/or information could be added to a filter list. In addition to filtering applications, the user may select websites to filter.

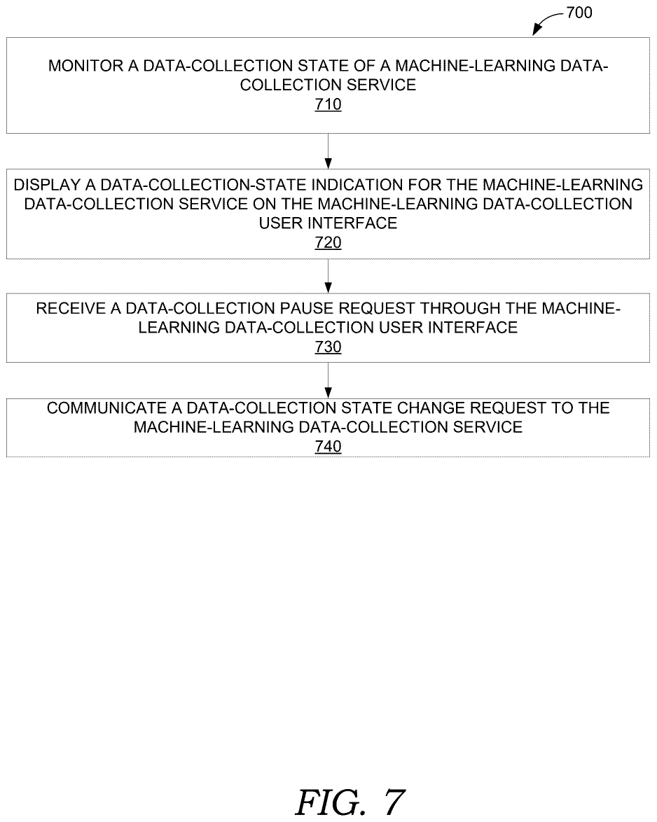

Now referring to FIGS. 7-9, each block of methods 700, 800, and 900 described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by a standalone application, a service or hosted service (standalone or in combination with another hosted service), to name a few. In addition, methods 700, 800, and 900 are described, by way of example, with respect to additional features of FIGS. 1-6. However, these methods may additionally or alternatively be executed by any one system, or any combination of systems, including, but not limited to, those described herein.

Referring now to FIG. 7, method 700 includes at step 710 monitoring a data-collection state of a machine-learning data-collection service. Method 700 includes at step 720 displaying a data-collection-state indication for the machine-learning data-collection service on the machine-learning data-collection user interface. Method 700 includes at step 730 receiving a data-collection pause request through the machine-learning data-collection user interface. Method 700 includes at step 740 communicating a data-collection state change request to the machine-learning data-collection service.

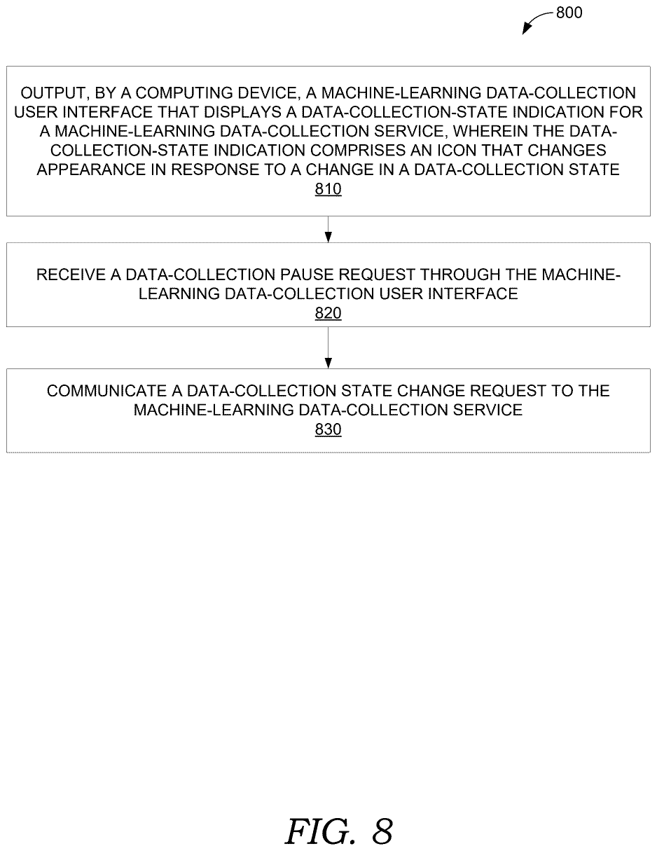

Referring now to FIG. 8, method 800 includes at step 810 outputting, by a computing device, a machine-learning data-collection user interface that displays a data-collection-state indication for a machine-learning data-collection service, wherein the data-collection-state indication comprises an icon that changes appearance in response to a change in a data-collection state. Method 800 includes at step 820 receiving a data-collection pause request through the machine-learning data-collection user interface. Method 800 includes at step 830 communicating a data-collection state change request to the machine-learning data-collection service.

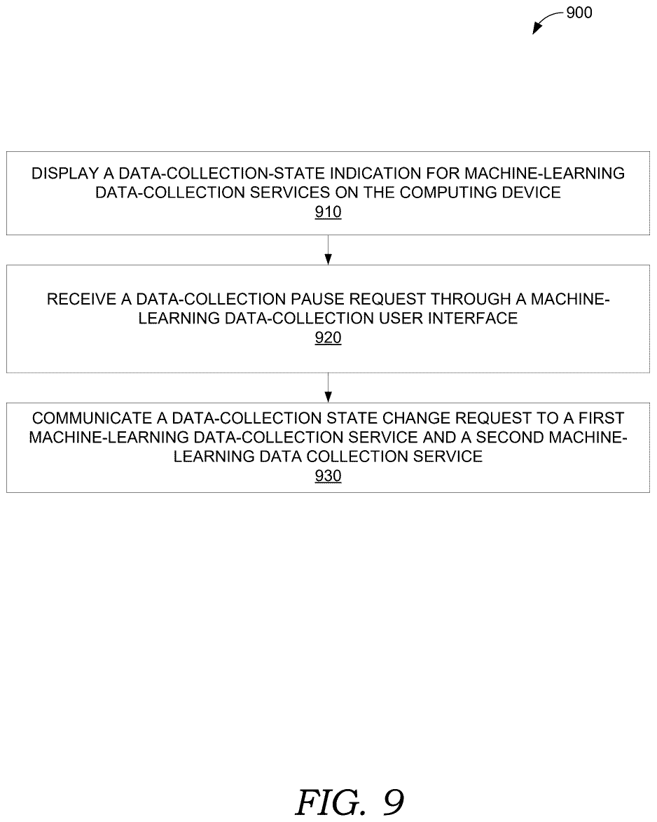

Referring now to FIG. 9, method 900 includes at step 910 displaying a data-collection-state indication for machine-learning data-collection services on the computing device. Method 900 includes at step 920 receiving a data-collection pause request through a machine-learning data-collection user interface. Method 900 includes at step 920 communicating a data-collection state change request to a first machine-learning data-collection service and a second machine-learning data collection service.

### Exemplary Operating Environment

Referring to the drawings in general, and initially to FIG. 10 in particular, an exemplary operating environment implementing aspects of the technology described herein is shown and designated generally as computing device 1000. Computing device 1000 is but one example of a suitable computing environment to implement a user device 102a comprising OS-level ML data-collection services 104, and is not intended to suggest any limitation as to the scope of use of the technology described herein. Neither should the computing device 1000 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, or similar computing devices. Aspects of the technology described herein may also be practiced in distributed computing environments where tasks are performed by remote-processing devices that are linked through a communications network.

With continued reference to FIG. 10, computing device 1000 includes a bus 1010 that directly or indirectly couples the following devices: memory 1012, one or more processors 1014, one or more presentation components 1016, input/output (I/O) ports 1018, I/O components 1022, and an illustrative power supply 1022. Bus 1010 represents what may be one or more busses (such as an address bus, data bus, or a combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 10 is merely illustrative of an exemplary computing device that may be used in connection with one or more aspects of the technology described herein. Distinction is not made between such categories as “workstation,” “server,” “laptop,” “handheld device,” or similar terms, as all are contemplated within the scope of FIG. 10 and refer to “computer” or “computing device.”

Computing device 1000 typically includes a variety of computer-readable media. Computer-readable media may be any available media that may be accessed by computing device 1000 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1012 includes computer storage media in the form of volatile and/or nonvolatile memory. The memory 1012 may be removable, non-removable, or a combination thereof. Exemplary memory includes solid-state memory, hard drives, optical-disc drives, or similar hardware devices. Computing device 1000 includes one or more processors 1014 that read data from various entities such as bus 1010, memory 1012, or I/O components 1022. Presentation component(s) 1016 present data indications to a user or other device. Exemplary presentation components 1016 include a display device, speaker, printing component, vibrating component, or similar audio output device. I/O ports 1018 allow computing device 1000 to be logically coupled to other devices, including I/O components 1022, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1014 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein. In various different embodiments, any of such I/O components may be included in a user device and utilized by a user to interact with the DC UI 223.

An NUI processes air gestures, voice, or other physiological inputs generated by a user. Appropriate NUI inputs may be interpreted as ink strokes for presentation in association with the computing device 1000. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 1000. The computing device 1000 may be equipped with depth cameras, such as stereoscopic camera systems, infrared camera systems, RGB camera systems, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

A computing device may include a radio 1024. The radio 1024 transmits and receives radio communications. The computing device may be a wireless terminal adapted to receive communications and media over various wireless networks. Computing device 1000 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. A system comprising:
one or more processors coupled to a memory;
an operating system executing on the one or more processors, the operating system comprising code to implement a machine-learning data-collection coordinator and to output machine-learning data-collection user interface, wherein the machine-learning data-collection coordinator:
monitors a data-collection state of a machine-learning data-collection service;
displays a data-collection-state indication for the machine-learning data-collection service on the machine-learning data-collection user interface;
receives a data-collection pause request through the machine-learning data-collection user interface; and
communicates a data-collection state change request to the machine-learning data-collection service.

2. The system of claim 1, wherein the machine-learning data-collection user interface is an element of an operating system taskbar, a system tray, a dock, an icon bar, a menu bar, a notification center, or a panel.

3. The system of claim 1, wherein the machine-learning data-collection user interface comprises an icon that changes appearance in response to a change in the data-collection state.

4. The system of claim 3, wherein the icon displayed by the machine-learning data-collection user interface comprises an interactive data-collection control.

5. The system of claim 1, wherein the machine-learning data-collection user interface includes a delete control that enables users to delete previously collected user activity data according to a category of user activity data.

6. The system of claim 5, wherein the category is a time period.

7. The system of claim 5, wherein the category is a user interface for a designation application being displayed during capture of the user activity data.

8. The system of claim 5, wherein the category is a specific website being displayed during capture the user activity data.

9. The system of claim 1, wherein the wherein the machine-learning data-collection user interface includes a filter control that enables users to prevent future collection of user activity data according to a user activity criteria.

10. A method for machine-learning data-collection management, the method comprising:
outputting, by a computing device, a machine-learning data-collection user interface that displays a data-collection-state indication for a machine-learning data-collection service, wherein the data-collection-state indication comprises an icon that changes appearance in response to a change in a data-collection state;
receiving a data-collection pause request through the machine-learning data-collection user interface; and
communicating a data-collection state change request to the machine-learning data-collection service.

11. The method of claim 10, wherein the icon is displayed in a non-obstructed location on a graphical user interface regardless of an application that is active.

12. The method of claim 10, wherein the machine-learning data-collection user interface includes a delete control that enables users to delete previously collected user activity data according to a category of user activity data, wherein the user activity data comprises a screen shot of a computer display at a point in time.

13. The method of claim 12, wherein the category is a user interface for a designation application being displayed during the user activity data.

14. The method of claim 10, wherein the wherein the machine-learning data-collection user interface includes a filter control that enables users to prevent future collection of user activity data according to a user activity criteria.

15. The method of claim 14, wherein the user activity criteria is a specific website being displayed during potential capture of the user activity data.

16. The method of claim 14, wherein the user activity criteria is a specific application interface being displayed during potential capture of the user activity data.

17. The method of claim 16, wherein the user activity data is stored locally on the computing device.

18. One or more computer storage media comprising computer-executable instructions that when executed by an operating system on a computing device cause the computing device to perform a method of machine-learning data collection management, the method comprising:
displaying a data-collection-state indication for machine-learning data-collection services on the computing device;
receiving a data-collection pause request through a machine-learning data-collection user interface; and
communicating a data-collection state change request to a first machine-learning data-collection service and a second machine-learning data collection service.

19. The media of claim 18, wherein the method further comprises receiving a first data collection pause confirmation from the first machine-learning data-collection service and a second data collection pause confirmation from the second machine-learning data collection service.

20. The media of claim 18, wherein the method further comprises:
receiving a data-collection restart request through the machine-learning data-collection user interface; and
communicating a second state change request to the first machine-learning data-collection service and the second machine-learning data collection service.
